(19) United States
(12) Patent Application Publication
(10) Pub. No.: US 2026/0067571 A1
(43) Pub. Date: Mar. 5, 2026

(54) IMAGE SENSING MODULE

(71) Applicant: GUANGZHOU LUXVISIONS INNOVATION TECHNOLOGY LIMITED, Guangzhou City (CN)

(72) Inventors: Cheng-Te Tseng, Guangzhou City (CN); Shu-Hung Liu, Guangzhou City (CN)

(73) Assignee: GUANGZHOU LUXVISIONS INNOVATION TECHNOLOGY LIMITED, Guangzhou City (CN)

(21) Appl. No.: 19/223,639

(22) Filed: May 30, 2025

(30) Foreign Application Priority Data
Sep. 2, 2024 (CN) 202411224586.X

(51) Int. Cl. H04N 23/68; H04N 23/54

(52) U.S. Cl. CPC H04N 23/687; H04N 23/54

(57) ABSTRACT

An image sensing module includes a substrate, an elastic support, an image sensor, a plurality of coil units, a substrate support, and a plurality of magnetic units. A fixed frame is arranged on an upper surface of the substrate and surrounds a movable plate, and the movable plate is connected to the fixed frame through a plurality of elastic conductive members. The image sensor is arranged on the movable plate. The plurality of coil units are arranged on a periphery of the image sensor. The substrate support includes a vertical plate and a horizontal plate. The vertical plate is arranged on the upper surface of the substrate, and the horizontal plate is connected to the vertical plate and parallel to the movable plate. The plurality of magnetic units are arranged on a lower surface of the horizontal plate and are respectively correspondingly arranged above the plurality of coil units.

### CROSS-REFERENCE TO RELATED APPLICATION

This non-provisional application claims priority under 35 U.S.C. § 119(a) to Patent Application No. 202411224586.X filed in China on Sep. 2, 2024, the entire contents of which are hereby incorporated by reference.

### BACKGROUND

### Technical Field

The present invention relates to an image sensing module, and in particular, to an image sensing module that can provide vibration compensation.

### Related Art

In today's image device market, an optical image stabilization (OIS) function has become one of the key technologies for improving image quality. An OIS technology is a technology for reducing or eliminating image blur caused by jitter of a camera or a mobile phone during photographing. Generally speaking, the technology mechanically achieves image stabilization, to improve the clarity and stability of photographing. Although a traditional OIS mechanism can effectively reduce image blur caused by hand shaking, a structural design thereof often leads to a thick and heavy camera module, which limits thinning and lightening of terminal products.

In order to solve the problem, a sensor-shift OIS technology comes into being. The sensor-shift OIS makes the structure of camera module more compact, to reduce a thickness of the camera module. The technology has a wide application range, which covers general cameras and various video-related products such as a front camera, a main camera, an auxiliary wide-angle camera, or a telephoto module of a mobile phone, a monitor, and a network camera.

However, it is an important issue in the development of the OIS technology to achieve a high-quality image stabilization function while maintaining a light and portable design to meet a need of consumers for both high performance and portability.

### SUMMARY

In view of the above, the applicant proposes an image sensing module, including a substrate, an elastic support, an image sensor, a plurality of coil units, a substrate support, and a plurality of magnetic units. The elastic support includes a fixed frame, a movable plate, and a plurality of elastic conductive members. The fixed frame is arranged on an upper surface of the substrate and surrounds the movable plate, and the movable plate is connected to the fixed frame through the plurality of elastic conductive members. The image sensor is arranged on the movable plate. The plurality of coil units are arranged on an upper surface of the movable plate and arranged on a periphery of the image sensor. The substrate support includes a vertical plate and a horizontal plate. The vertical plate is arranged on the upper surface of the substrate, and the horizontal plate is connected to the vertical plate and parallel to the movable plate. The plurality of magnetic units are arranged on a lower surface of the horizontal plate and are respectively correspondingly arranged above the plurality of coil units.

In an embodiment of the above image sensing module, the image sensing module includes a lens and a focusing motor, the focusing motor surrounds the lens, the horizontal plate has a first light-transmitting hole, the focusing motor is arranged on an upper surface of the horizontal plate, and the lens corresponds to the first light-transmitting hole.

In an embodiment of the above image sensing module, the elastic conductive member includes two vertical portions and one horizontal portion, two ends of the horizontal portion are respectively connected to the two vertical portions through a smooth bent portion, one of the two vertical portions is connected to the fixed frame, and the other of the two vertical portions is connected to the movable plate.

In an embodiment of the above image sensing module, each of the plurality of coil units includes a coil and a magnetic sensor, and the coil and the magnetic sensor correspond to an underside of the same one of the plurality of magnetic units.

In an embodiment of the above image sensing module, the magnetic sensor of each of the plurality of coil units is arranged at a geometric center of the coil.

In an embodiment of the above image sensing module, the image sensor has a photosensitive area, the movable plate has a second light-transmitting hole, the image sensor is arranged on a lower surface of the movable plate, and the photosensitive area corresponds to the second light-transmitting hole.

In an embodiment of the above image sensing module, the image sensor is connected to the movable plate through wire bonding, and the fixed frame is connected to the substrate through wire bonding.

The applicant further proposes an image sensing module, including a substrate, an elastic support, an image sensor, a filter support, a plurality of coil units, a substrate support, and a plurality of magnetic units. The elastic support includes a fixed frame, a movable plate, and a plurality of elastic conductive members. The fixed frame is arranged on an upper surface of the substrate and surrounds the movable plate, and the movable plate is connected to the fixed frame through the plurality of elastic conductive members. The image sensor is arranged on an upper surface of the movable plate. The filter support is arranged on the upper surface of the movable plate. An upper surface of the filter support is spaced apart from the movable plate by a first height. The plurality of coil units are arranged on the upper surface of the movable plate and arranged on a periphery of the image sensor. An upper surface of each of the plurality of coil units is spaced apart from the movable plate by a second height. The substrate support includes a vertical plate and a horizontal plate. The vertical plate is arranged on the upper surface of the substrate, and the horizontal plate is connected to the vertical plate and parallel to the movable plate. The plurality of magnetic units are arranged on a lower surface of the horizontal plate and are respectively correspondingly arranged above the plurality of coil units. A lower surface of each of the plurality of magnetic units is spaced apart from the horizontal plate by a third height. A sum of the second height and the third height is less than the first height.

In an embodiment of the above image sensing module, the plurality of coil units are respectively connected to outer surfaces on a periphery of the filter support.

In an embodiment of the above image sensing module, the image sensing module further includes a filter, the filter support is a frame, an inner surface of the frame has a transverse plate protruding inward, the filter is arranged on an upper surface of the transverse plate and parallel to the movable plate, and the first height is greater than a sum of thicknesses of the filter and the image sensor.

### BRIEF DESCRIPTION OF THE DRAWINGS

FIG. 1A is a schematic top view of an image sensing module according to an embodiment of the present invention.

FIG. 1B is a schematic side view of the image sensing module according to an embodiment of the present invention.

FIG. 2 is a schematic sectional view of an image sensing module according to an embodiment of the present invention.

FIG. 3 is a schematic exploded view of an image sensing module according to an embodiment of the present invention.

FIG. 4A is a schematic top view of an elastic support according to an embodiment of the present invention.

FIG. 4B is a partial schematic enlarged view of the elastic support according to an embodiment of the present invention.

FIG. 4C is a schematic sectional view of the elastic support according to an embodiment of the present invention.

FIG. 5 is an assembly flowchart of an image sensing module according to an embodiment of the present invention.

FIG. 6 is an assembly flowchart of a lens unit according to an embodiment of the present invention.

FIG. 7 is a schematic diagram of an assembly mode of an image sensing module according to an embodiment of the present invention.

FIG. 8 is a schematic diagram of an assembly mode of an elastic support according to an embodiment of the present invention.

FIG. 9 is a schematic diagram of an assembly mode of a filter support according to an embodiment of the present invention.

FIG. 10 is a schematic layout diagram of coil units according to an embodiment of the present invention.

FIG. 11 is a schematic diagram of an assembly mode of a substrate support according to an embodiment of the present invention.

FIG. 12A is a schematic layout diagram of magnetic units according to an embodiment of the present invention.

FIG. 12B is a corresponding schematic layout diagram of coil units and the magnetic units according to an embodiment of the present invention.

FIG. 13 is a schematic diagram of vibration compensation of an image sensing module according to an embodiment of the present invention.

### DETAILED DESCRIPTION

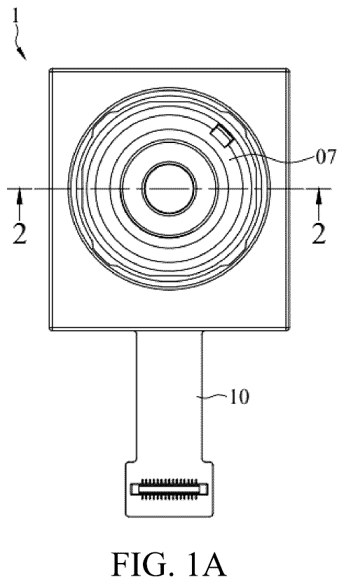

Referring to FIG. 1A and FIG. 1B together, FIG. 1A is a schematic top view of an image sensing module according to an embodiment of the present invention, and FIG. 1B is a schematic side view of the image sensing module according to an embodiment of the present invention. In this embodiment, an image sensing module 1 includes a substrate support 05, a lens unit 07, and a flexible substrate 10. The lens unit 07 is arranged on an upper surface of the substrate support 05, and the lens unit 07 is electrically connected to the flexible substrate 10. The image sensing module 1 may be applied to an electronic device, and the flexible substrate 10 may be electrically connected to the electronic device through a connector, welding, or wire bonding. The electronic device may be, but is not limited to, a mobile phone, a tablet computer, a camera, a monitor, a webcam, a notebook computer, or a personal computer.

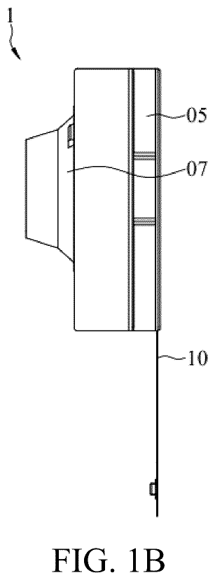

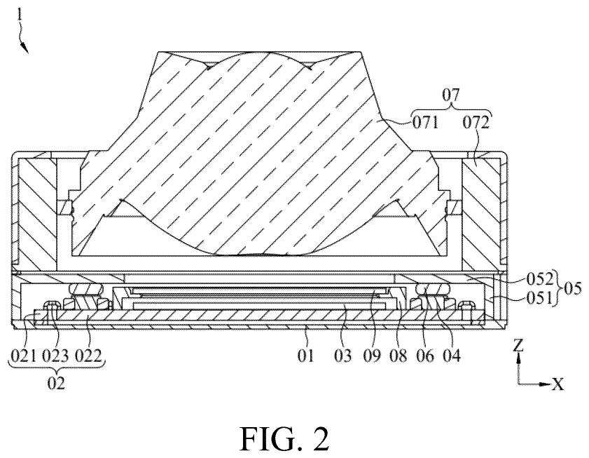

Referring to FIG. 2 and FIG. 3 together, FIG. 2 is a schematic sectional view of the image sensing module according to an embodiment of the present invention, and FIG. 3 is a schematic exploded view of the image sensing module according to an embodiment of the present invention. In this embodiment, the image sensing module 1 includes a substrate 01, an elastic support 02, an image sensor 03, a plurality of coil units 04, a substrate support 05, and a plurality of magnetic units 06. The elastic support 02 is arranged on a surface of the substrate 01, the image sensor 03 is arranged on a surface of the elastic support 02, the plurality of coil units 04 are arranged on the surface of the elastic support 02, the substrate support 05 is arranged on the surface of the substrate 01, and the plurality of magnetic units 06 are arranged on a surface of the substrate support 05.

The substrate 01 may be a rigid substrate or a flexible substrate 10, and the substrate 01 includes wires for electrically connecting to an electronic device outside the image sensing module 1 and components inside the image sensing module, such as the image sensor 03 or the coil units 04. A material of the substrate 01 may be but is not limited to glass fiber, composite epoxy resin, alumina (Al2O3), aluminum nitride (AlN), polytetrafluoroethylene (PTFE), polyethylene terephthalate (PET), or polyimide (PI).

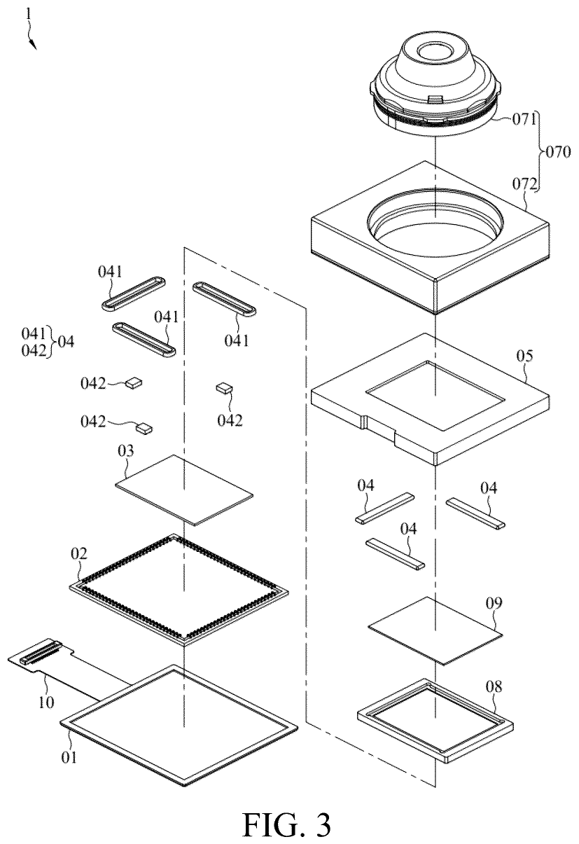

Referring to FIG. 4A and FIG. 4B together, FIG. 4A is a schematic top view of an elastic support according to an embodiment of the present invention, and FIG. 4B is a partial schematic enlarged view of the elastic support according to an embodiment of the present invention. The elastic support 02 includes a fixed frame 021, a movable plate 022, and a plurality of elastic conductive members 023. The fixed frame 021 of the elastic support 02 is arranged on an upper surface of the substrate 01 and surrounds the movable plate 022, and the movable plate 022 is connected to the fixed frame 021 through the plurality of elastic conductive members 023. The movable plate 022 includes wires for electrically connecting to the image sensor 03 or the coil units 04, the fixed frame 021 includes wires for electrically connecting to the substrate 01, and the elastic conductive members 023 are electrically connected to the movable plate 022 and the fixed frame 021. Materials of the movable plate 022 and the fixed frame 021 may respectively be but are not limited to glass fiber, composite epoxy resin, alumina, aluminum nitride, PTFE, PET, or PI. The elastic conductive members 023 have elasticity and conductivity, and a material thereof may be, but is not limited to, metal, PET, PI, conductive rubber, polyaniline (PANI), polypyrrole (PPy), polythiophene (poly(3,4-ethylenedioxythiophene) (PEDOT)), a carbon nanotube (CNT) composite material, a graphene composite material, and conductive fabric.

By virtue of elasticity of the plurality of elastic conductive members 023, the movable plate 022 is suspended in a range defined by the fixed frame 021, and can move freely in the range. As shown in FIG. 4A, the fixed frame 021 in this embodiment is a quadrilateral frame, the movable plate 022 is a quadrilateral plate, and an inner side length of the fixed frame 021 is greater than a side length of the movable plate 022. The plurality of elastic conductive members 023 are arranged near the four sides of the fixed frame 021, and the movable plate 022 is allowed to move freely in a small range on a plane formed by a coordinate axis X and a coordinate axis Y, for example, move leftward and rightward along the coordinate axis X, moving upward and downward along the coordinate axis Y, or rotating in the XY plane.

Referring to FIG. 4C, FIG. 4C is a schematic sectional view of the elastic support according to an embodiment of the present invention. In an embodiment, each of the elastic conductive members 023 includes two vertical portions 0231 and one horizontal portion 0232, and two ends of the horizontal portion 0232 are respectively connected to the vertical portions 0231 through a smooth bent portion 0233. One vertical portion 0231 of the elastic conductive member 023 is connected to the fixed frame 021, and the other vertical portion 0231 is connected to the movable plate 022. Under an action of the vertical portion 0231 of the elastic conductive member 023 in a direction of a coordinate axis Z, the movable plate 022 limits free movement of the movable plate 022 in the direction of the coordinate axis Z. In this embodiment, the elastic conductive member 023 is arranged on an upper surfaces of the fixed frame 021 and the movable plate 022. In other embodiments, the elastic conductive member 023 may be arranged on lower surfaces of the fixed frame 021 and the movable plate 022, to generate a force in the direction of the coordinate axis Z.

The image sensor 03 is arranged on the movable plate 022. Refer to FIG. 3 and FIG. 4A. In this embodiment, the image sensor 03 is arranged on an upper surface of the movable plate 022. The image sensor 03 may be, but is not limited to, a charge-coupled device (CCD) or a complementary metal-oxide-semiconductor active pixel sensor (CMOS active pixel sensor). When the movable plate 022 moves freely within the range defined by the fixed frame 021, the image sensor 03 moves accordingly. The image sensor 03 is electrically connected to the movable plate 022. Specifically, the image sensor 03 detects light and generates an image sensing signal. The image sensing signal passes through the movable plate 022, the elastic conductive member 023, the fixed frame 021, and the substrate 01 in sequence, and reaches the electronic device.

The plurality of coil units 04 are arranged on the upper surface of the movable plate 022 and are arranged on a periphery of the image sensor 03. As shown in FIG. 3, the image sensor 03 includes three coil units 04, which are arranged on the upper surface of the movable plate 022 near outer sides of three sides of the image sensor 03. In an embodiment, the coil unit 04 has a strip-like structure, and is parallel to any side of the image sensor 03. In an embodiment, the coil unit 04 includes a coil 041 and a magnetic sensor 042. A material of the coil 041 may be but is not limited to copper, aluminum, a silver-plated copper wire, a tin-plated copper wire, iron, or a superconducting material. The magnetic sensor 042 may be, but is not limited to, a Hall sensor, a magnetoresistive effect sensor, or a magnetic field effect transistor (magnetic field sensitive MOSFET, MAGFET). The image sensor 03 includes two or more coil units 04. In this embodiment, the image sensor 03 includes three coil units 04 configured to measure or compensate for a deviation along the coordinate axis X or Y.

The plurality of coil units 04 are electrically connected to the movable plate 022. In detail, the electronic device generates a plurality of control signals, and each control signal passes through the substrate 01, the fixed frame 021, the elastic conductive member 023, and the movable plate 022 in sequence, and reaches one of the coils 041. Alternatively, the magnetic sensor 042 detects a change of a magnetic field and generates a magnetic field sensing signal, and the magnetic field sensing signal passes through the movable plate 022, the elastic conductive piece 023, the fixed frame 021, and the substrate 01 in sequence, and reaches the electronic device. In an embodiment, the magnetic sensor 042 detects a deviation of the movable plate 022 and feeds back the deviation to the electronic device, and the electronic device generates a control signal in response to the deviation. According to the Ampere's law, a moving charge of the control signal flowing through the coil 041 generates a magnetic pole, to compensate for the deviation of the movable plate 022, which is described in detail later. In an embodiment, the magnetic sensor 042 of the coil unit 04 is arranged at a geometric center of the coil 041, and is configured to detect a magnetic field passing through the geometric center of the coil 041, so as to accurately estimate the deviations of the coil unit 04 and the movable plate 022.

Referring to FIG. 2 again, the substrate support 05 includes a vertical plate 051 and a horizontal plate 052. The vertical plate 051 is arranged on the upper surface of the substrate 01, and the horizontal plate 052 is connected to the vertical plate 051 and parallel to the movable plate 022. In other words, the horizontal plate 052 is suspended above the movable plate 022, and the horizontal plate 052 serves as a platform for carrying other components. As shown in FIG. 2, the image sensing module 1 includes a substrate 01, an elastic support 02, an image sensor 03, a plurality of coil units 04, a substrate support 05, a plurality of magnetic units 06, a lens 071, and a focusing motor 072. The lens 071 is arranged in the focusing motor 072, and the lens 071 and the focusing motor 072 are arranged on the horizontal plate 052 of the substrate support 05. A height of the vertical plate 051 needs to be determined in consideration of a height of the image sensor 03 or other components, and the height of the vertical plate 051 affects an overall thickness of the image sensing module 1.

The plurality of magnetic units 06 are arranged on a lower surface of the horizontal plate 052 and are respectively corresponding arranged above the coil units 04. As shown in FIG. 3, the image sensor 03 includes three magnetic units 06 correspondingly arranged on the lower surface of the horizontal plate 052 above the three coil units 04. Therefore, the height of the vertical plate 051 of the substrate support 05 is equivalent to a sum of the thickness of the magnetic units 06, the thickness of the coil units 04, and a distance between the two. A material of the magnetic units 06 may be, but is not limited to, a permanent magnetic material (such as neodymium iron boron (NdFeB), alnico, and bismuth ferrite (BFO)), a soft magnetic material (such as a ferrite or an iron-nickel alloy), or an electromagnetic coil. When the coils 041 of the coil units 04 generate magnetic poles, attraction or repulsion occurs between the coils and the magnetic units 06, causing the movable plate 022 to move. In addition, when the movable plate 022 deviates, a relative position of the magnetic units 06 and the coil units 04 change, causing a change in a magnetic flux passing through the coil unit 04, which is detected by the magnetic sensor 042. In an embodiment, the coil 041 and the magnetic sensor 042 correspond to an underside of the same magnetic unit 06. Therefore, the magnetic field sensing signal generated by the magnetic sensor 042 directly corresponds to a deviation of the magnetic units 06 relative to the coil units 04, and the electronic device may output a control signal to the coil 041 of the same coil unit 04 to compensate for the deviation.

In an embodiment, the image sensing module 1 includes a substrate 01, an elastic support 02, an image sensor 03, a plurality of coil units 04, a substrate support 05, a plurality of magnetic units 06, a filter support 08, and a filter 09. The elastic support 02 is arranged on a surface of the substrate 01, the image sensor 03 is arranged on a surface of the elastic support 02, the plurality of coil units 04 are arranged on the surface of the elastic support 02, the substrate support 05 is arranged on the surface of the substrate 01, the plurality of magnetic units 06 are arranged on the surface of the substrate support 05, the filter support 08 is arranged on the upper surface of the movable plate 022, and the filter 09 is arranged above the filter support 08. The filter 09 is configured to protect the image sensor 03 or filter light incident onto the image sensor 03, and the filter support 08 is configured to fix the filter 09. In this embodiment, a height of the filter support 08 defines a minimum height of the vertical plate 051 of the substrate support 05, and the minimum height needs to be determined in consideration of a sum of a thickness of the image sensor 03, a thickness of the filter 09, and a distance between the two.

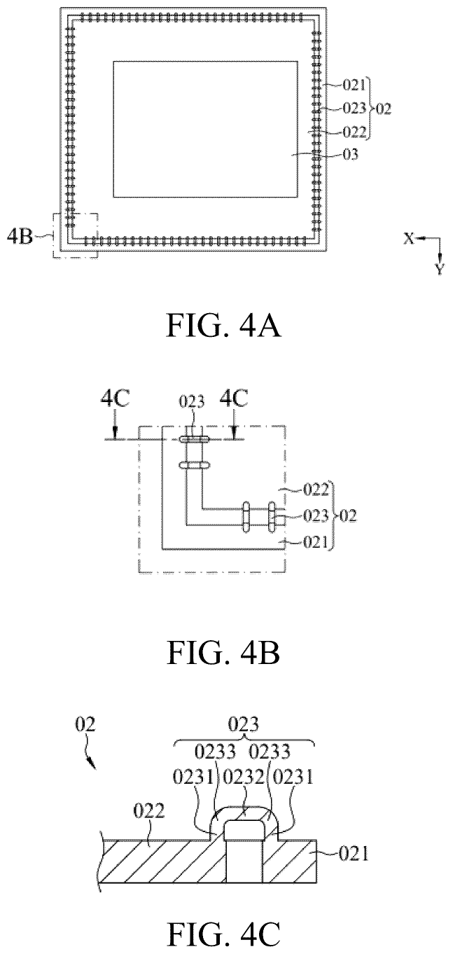

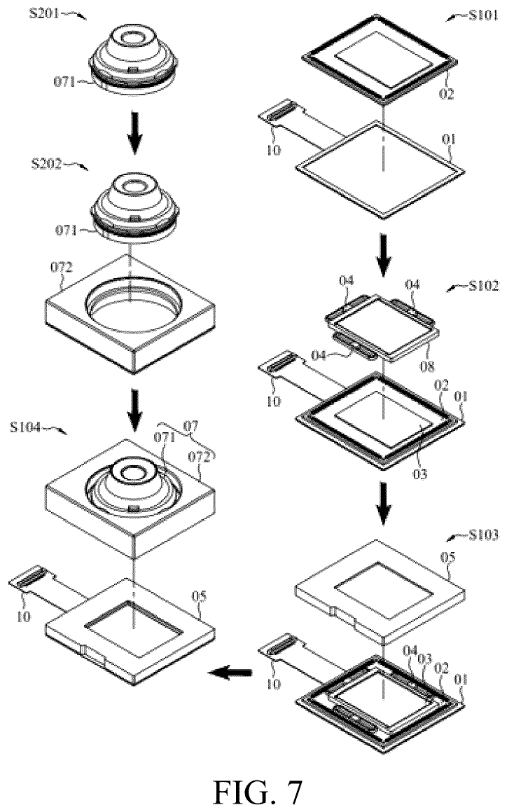

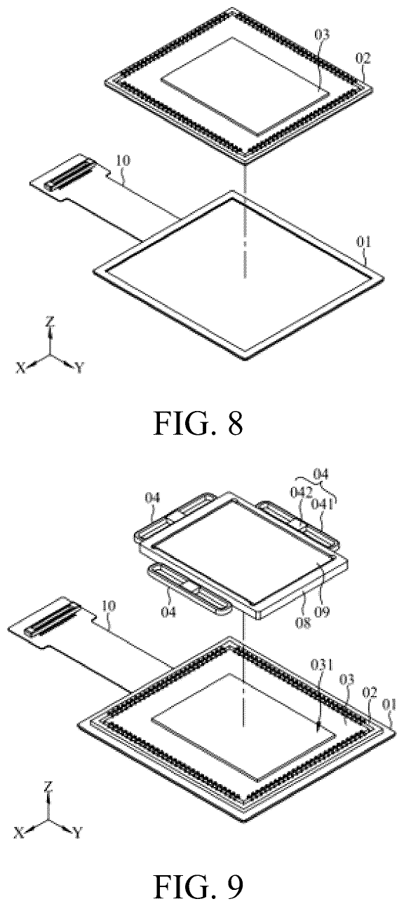

Referring to FIG. 5, FIG. 7, and FIG. 8, FIG. 5 is an assembly flowchart of the image sensing module according to an embodiment of the present invention, FIG. 7 is a schematic diagram of an assembly mode of the image sensing module according to an embodiment of the present invention, and FIG. 8 is a schematic diagram of an assembly mode of the elastic support according to an embodiment of the present invention. The assembly mode of the image sensing module 1 in an embodiment of the present disclosure is described below with different embodiments. The assembly mode of the image sensing module 1 may be adjusted based on process requirements, and is not limited to the assembly mode in the following embodiment. In step S101 of an assembly method for the image sensing module 1, the elastic support 02 is arranged on the substrate 01. In this embodiment, the fixed frame 021 of the elastic support 02 may be fixed to the upper surface of the substrate 01 through gluing and/or welding. The image sensor 03 may be electrically connected to the elastic support 02 through welding or wire bonding, and the fixed frame 021 may be electrically connected to the substrate 01 through welding or wire bonding.

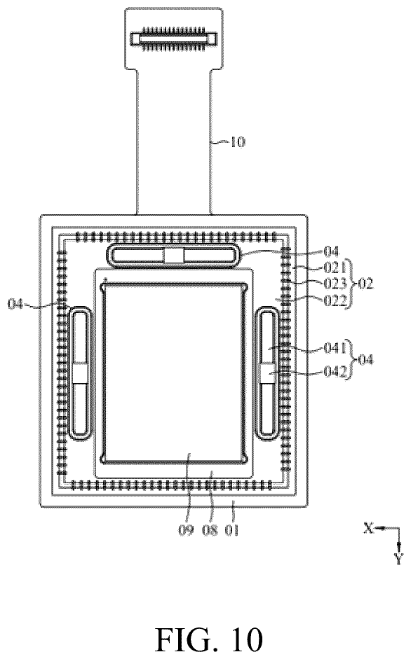

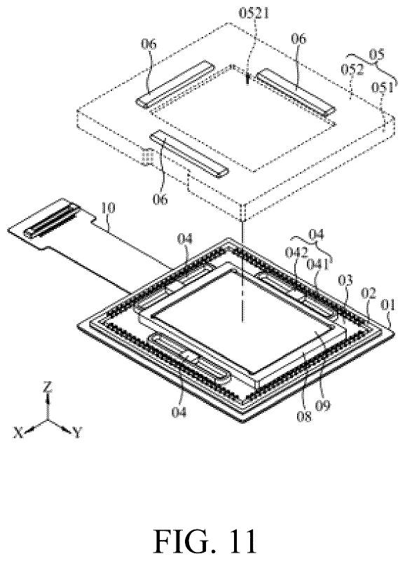

In step S102 of the assembly method for the image sensing module 1, the filter support 08 and the coil unit 04 are arranged on the elastic support 02. Referring to FIG. 9 and FIG. 10, FIG. 9 is a schematic diagram of an assembly mode of a filter support according to an embodiment of the present invention, and FIG. 10 is a schematic layout diagram of coil units according to an embodiment of the present invention. In this embodiment, the filter 09 may be fixed to the filter support 08 through gluing or snap-fitting, the filter support 08 may be fixed to the upper surface of the movable plate 022 of the elastic support 02 through gluing, and the coil unit 04 may be fixed to the upper surface of the movable plate 022 of the elastic support 02 through gluing and/or welding. In an embodiment, the plurality of coil units 04 are respectively connected to outer surfaces on a periphery of the filter support 08. As shown in FIG. 9, the image sensor 03 includes three coil units 04, which are respectively connected to three sides of the filter support 08. The coil units 04 may be first fixed to an outer surface of the filter support 08 through gluing or snap-fitting, to form an integral structure, and then the integral structure may be fixed to the upper surface of the movable plate 022 of the elastic support 02 through gluing and/or welding, thereby improving assembly positioning accuracy and reducing process complexity.

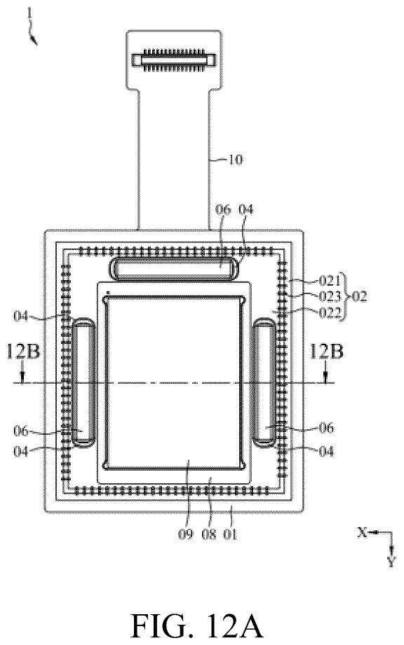

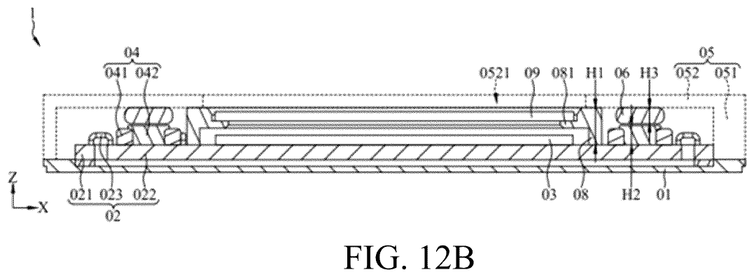

In step S103 of the assembly method for the image sensing module 1, the substrate support 05 is arranged on the substrate 01. Referring to FIG. 11, FIG. 11 is a schematic diagram of an assembly mode of a substrate support according to an embodiment of the present invention. The magnetic units 06 may be fixed to the lower surface of the horizontal plate 052 of the substrate support 05 through gluing and/or welding, and the vertical plate 051 of the substrate support 05 may be fixed to the substrate 01 through gluing and/or welding. A fixing position of the magnetic units 06 on the substrate support 05 corresponds to a fixing position of the coil units 04 on the elastic support 02. FIG. 12A is a schematic layout diagram of magnetic units according to an embodiment of the present invention. As shown in FIG. 12A, when the substrate support 05 is fixed at a default position on the substrate 01, the magnetic units 06 are exactly located above the coil units 04. In this embodiment, the image sensor 03 has a photosensitive area 031, and the horizontal plate 052 of the substrate support 05 has a first light-transmitting hole 0521. Light can irradiate the photosensitive area 031 of the image sensor 03 through the first light-transmitting hole 0521.

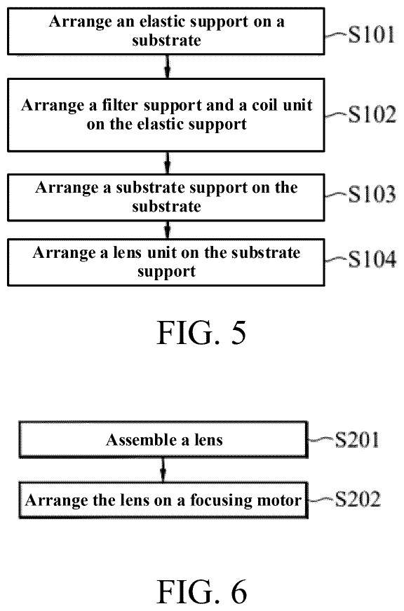

In step S104 of the assembly method for the image sensing module 1, the lens unit 07 is arranged on the substrate support 05. In this embodiment, the lens unit 07 includes a lens 071 and a focusing motor 072. The focusing motor 072 may be, but is not limited to, a voice coil motor (VCM), a stepping motor, a direct current motor, a piezoelectric actuator, or a magnetostrictive actuator. Referring to FIG. 6, FIG. 6 is an assembly flowchart of a lens unit according to an embodiment of the present invention. After the lens 071 is assembled (step S201), the lens 071 is arranged on the focusing motor 072 (step S202). As shown in FIG. 2, the focusing motor 072 surrounds the lens 071, and is configured to drive the lens 071 to move upward and downward to achieve focusing. In this embodiment, the focusing motor 072 is arranged on the upper surface of the horizontal plate 052, and the lens 071 corresponds to the first light-transmitting hole 0521 of the horizontal plate 052 of the substrate support 05, so that light can irradiate the photosensitive area 031 of the image sensor 03 through the lens unit 07 and the first light-transmitting hole 0521. In another embodiment, the movable plate 022 of the elastic support 02 has a second light-transmitting hole (not shown), and the image sensor 03 is arranged on a lower surface of the movable plate 022. A projection range of the second light-transmitting hole covers the photosensitive area 031 of the image sensor 03. In this way, light can irradiate the photosensitive area 031 of the image sensor 03 below the movable plate 022 through the first light-transmitting hole 0521 and the second light-transmitting hole.

Referring to FIG. 12B, FIG. 12B is a corresponding schematic layout diagram of coil units and the magnetic units according to an embodiment of the present invention. Coordinate ranges of the coil units 04 and the magnetic units 06 on the XY plane overlap, and the coil units 04 are located directly below the magnetic units 06. In this embodiment, the filter support 08 is arranged on the upper surface of the movable plate 022, and an upper surface of the filter support 08 is spaced apart from the upper surface of the movable plate 022 by a first height H1, upper surfaces of the coil units 04 are spaced apart from the upper surface of the movable plate 022 by a second height H2, lower surfaces of the magnetic units 06 are spaced apart from the lower surface of the horizontal plate 052 by a third height H3, and a sum of the second height H2 and the third height H3 is less than the first height H1. In this embodiment, because the filter support 08 is configured to fix the filter 09, the first height H1 is limited by thicknesses of the filter 09 and the image sensor 03. In an embodiment, the filter support 08 is a frame, and an inner surface of the frame has a transverse plate 081 protruding inward, and the filter 09 is arranged on an upper surface of the transverse plate 081 and parallel to the movable plate 022. In this embodiment, the upper surface of the filter 09 is coplanar with a top surface of the filter support 08, and the first height H1 is greater than a sum of the thicknesses of the filter 09 and the image sensor 03. In order to effectively utilize an existing space within the first height H1, the magnetic units 06 are arranged on the lower surface of the horizontal plate 052 and correspondingly arranged on the coil units 04, so as to avoid additional increase in the thickness of the image sensing module 1 caused by the magnetic units 06 or the coil units 04, thereby realizing OIS while satisfying the market demand for lightening and thinning and portability.

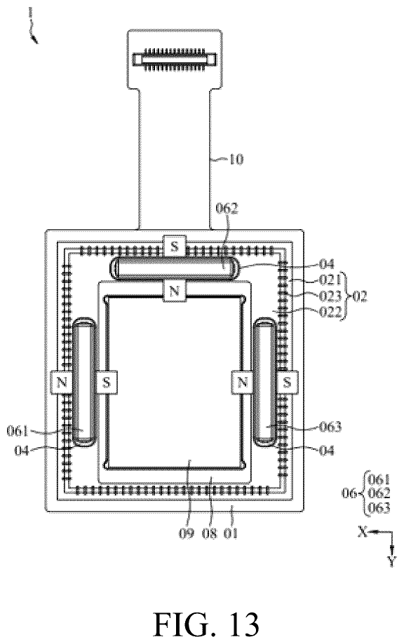

Referring to FIG. 13, FIG. 13 is a schematic diagram of vibration compensation of an image sensing module according to an embodiment of the present invention. In this embodiment, the plurality of magnetic units 06 include a magnet 061, a magnet 062, and a magnet 063. The magnet 061 has a magnetic pole N on an outer side and a magnetic pole S on an inner side. The magnet 062 has a magnetic pole S on an outer side and a magnetic pole N on an inner side. The magnet 063 has a magnetic pole S on an outer side and a magnetic pole N on an inner side. When the movable plate 022 moves rightward along the coordinate axis X due to hand shaking, the coil units 04 corresponding to the magnet 061 and magnet 063 deviate toward the magnetic pole N, resulting in a magnetic flux change. When the movable plate 022 moves downward along the coordinate axis Y due to hand shaking, the coil unit 04 corresponding to the magnet 062 deviates toward the magnetic pole S, resulting in a magnetic flux change. The magnetic flux change may be measured by the magnetic sensor 042 of the coil unit 04, and a magnetic field sensing signal may be generated. The electronic device may estimate a deviation of the image sensor 03 based on the magnetic field sensing signal and generate a control signal needed to compensate for the deviation. The coil unit 04 receives the control signal and generates a magnetic pole, which generates attraction or repulsion with the magnetic unit 06 to realize vibration compensation.

Although the present invention has been disclosed with the foregoing embodiments, the embodiments are not intended to limit the present invention. Any person of ordinary skill in the art may make some changes and modifications without departing from the spirit and scope of the present invention. Therefore, the protection scope of the present invention is subject to the appended claims.

What is claimed is:

1. An image sensing module, comprising:
a substrate;
an elastic support, comprising a fixed frame, a movable plate, and a plurality of elastic conductive members, wherein the fixed frame is arranged on an upper surface of the substrate and surrounds the movable plate, and the movable plate is connected to the fixed frame through the plurality of elastic conductive members;
an image sensor, arranged on the movable plate;
a plurality of coil units, arranged on an upper surface of the movable plate and arranged on a periphery of the image sensor;
a substrate support, comprising a vertical plate and a horizontal plate, wherein the vertical plate is arranged on the upper surface of the substrate, and the horizontal plate is connected to the vertical plate and parallel to the movable plate; and
a plurality of magnetic units, arranged on a lower surface of the horizontal plate and respectively correspondingly arranged above the plurality of coil units.

2. The image sensing module according to claim 1, comprising a lens and a focusing motor, wherein the focusing motor surrounds the lens, the horizontal plate has a first light-transmitting hole, the focusing motor is arranged on an upper surface of the horizontal plate, and the lens corresponds to the first light-transmitting hole.

3. The image sensing module according to claim 1, wherein the elastic conductive member comprises two vertical portions and one horizontal portion, two ends of the horizontal portion are respectively connected to the two vertical portions through a smooth bent portion, one of the two vertical portions is connected to the fixed frame, and the other of the two vertical portions is connected to the movable plate.

4. The image sensing module according to claim 1, wherein each of the plurality of coil units comprises a coil and a magnetic sensor, and the coil and the magnetic sensor correspond to an underside of the same one of the plurality of magnetic units.

5. The image sensing module according to claim 4, wherein the magnetic sensor of each of the plurality of coil units is arranged at a geometric center of the coil.

6. The image sensing module according to claim 1, wherein the image sensor has a photosensitive area, the movable plate has a second light-transmitting hole, the image sensor is arranged on a lower surface of the movable plate, and the photosensitive area corresponds to the second light-transmitting hole.

7. The image sensing module according to claim 1, wherein the image sensor is connected to the movable plate through wire bonding, and the fixed frame is connected to the substrate through wire bonding.

8. An image sensing module, comprising:
a substrate;
an elastic support, comprising a fixed frame, a movable plate, and a plurality of elastic conductive members, wherein the fixed frame is arranged on an upper surface of the substrate and surrounds the movable plate, and the movable plate is connected to the fixed frame through the plurality of elastic conductive members;
an image sensor, arranged on an upper surface of the movable plate;
a filter support, arranged on the upper surface of the movable plate, wherein an upper surface of the filter support is spaced apart from the movable plate by a first height;
a plurality of coil units, arranged on the upper surface of the movable plate and arranged on a periphery of the image sensor, wherein an upper surface of each of the plurality of coil units is spaced apart from the movable plate by a second height;
a substrate support, comprising a vertical plate and a horizontal plate, wherein the vertical plate is arranged on the upper surface of the substrate, and the horizontal plate is connected to the vertical plate and parallel to the movable plate; and
a plurality of magnetic units, arranged on a lower surface of the horizontal plate and respectively correspondingly arranged above the plurality of coil units, wherein a lower surface of each of the plurality of magnetic units is spaced apart from the horizontal plate by a third height, and a sum of the second height and the third height is less than the first height.

9. The image sensing module according to claim 8, wherein the plurality of coil units are respectively connected to outer surfaces on a periphery of the filter support.

10. The image sensing module according to claim 8, comprising a filter, wherein the filter support is a frame, an inner surface of the frame has a transverse plate protruding inward, the filter is arranged on an upper surface of the transverse plate and parallel to the movable plate, and the first height is greater than a sum of thicknesses of the filter and the image sensor.
